(19) United States
(12) Patent Application Publication
(10) Pub. No.: US 2018/0203504 A1
(43) Pub. Date: Jul. 19, 2018

(54) MOVEMENT TRACKING METHOD AND MOVEMENT TRACKING SYSTEM

(71) Applicant: HTC Corporation, Taoyuan City (TW)

(72) Inventor: Hsin-Yu LU, Taoyuan City (TW)

(73) Assignee: HTC Corporation, Taoyuan City (TW)

(21) Appl. No.: 15/852,256

(22) Filed: Dec. 22, 2017

Related U.S. Application Data
(60) Provisional application No. 62/446,538, filed on Jan. 16, 2017.

(51) Int. Cl. G06F 3/01; H04N 5/232; G06T 7/20; G02B 27/01

(52) U.S. Cl. CPC G06F 3/012; G02B 27/017; G06T 7/20; H04N 5/23254

(57) ABSTRACT

One aspect of the present disclosure is related to a movement tracking method for an electronic apparatus. The movement tracking method for an electronic apparatus comprises: obtaining information of a first frame captured by a camera; obtaining (inertial measurement unit) IMU information from an IMU sensor; calculating a first blurred pixel parameter of the first frame according to the information of the first frame and the IMU information by a processor; and determining whether the first blurred pixel parameter of the first frame is smaller than a blur threshold or not by the processor; if the first blurred pixel parameter of the first frame is smaller than the blur threshold, calculating a movement data of the electronic apparatus according to the information of the first frame and the IMU information.

This application claims the benefit of U.S. provisional application Ser. No. 62/446,538, filed on Jan. 16, 2017, the subject matter of which is incorporated herein by reference.

### BACKGROUND

### Field of Invention

The present invention relates to a movement tracking method and a movement tracking system. More particularly, the present invention relates to movement tracking method and a movement tracking system for improving the quality of tracking technology.

### Description of Related Art

Recently, virtual reality system is becoming increasingly popular. Virtual reality system can be applied for movies, virtual reality, or other interactive applications. In general, a head mounted display is an important part of a virtual reality system. Users can see the virtual world by wearing the head mounted display. To be more specifically, the head mounted display typically consist of a display or plurality of displays and relay optics which deliver computer generated graphics to the eyes of users.

In common user behavior, user may move their head to interact with the virtual content. If tracking technology can't provide exact the position measured, not corresponding to the movement of the user, the user may feel uncomfortable or get seasick. Therefore, it is important to provide a method and a system to generate the correct and exact variation in movement in virtual reality corresponding to the movement of the user.

### SUMMARY

One aspect of the present disclosure is related to a movement tracking method for an electronic apparatus. The movement tracking method for an electronic apparatus comprises: obtaining information of a first frame captured by a camera; obtaining (inertial measurement unit) IMU information from an IMU sensor; calculating a first blurred pixel parameter of the first frame according to the information of the first frame and the IMU information by a processor; and determining whether the first blurred pixel parameter is smaller than a blur threshold or not by the processor; if the first blurred pixel parameter is smaller than the blur threshold, calculating a movement data of the electronic apparatus according to the information of the first frame and the IMU information.

Another aspect of the present disclosure is related to a movement tracking system for an electronic apparatus. In accordance with one embodiment of the present disclosure, the movement tracking system includes a camera, an IMU sensor and a processor. The camera captures a first frame. The IMU sensor detects (inertial measurement unit) IMU information. The processor obtains information of the first frame and calculating a first blurred pixel parameter of the first frame according to information of the first frame and the IMU information. The processor determines whether the first blurred pixel parameter is smaller than a blur threshold or not. If the first blurred pixel parameter of the first frame is smaller than the blur threshold, the processor calculates a movement data of the electronic apparatus according to the information of the first frame and the IMU information.

In this embodiment, the movement tracking method and a movement tracking system can precisely calculate the moving distance of the electronic apparatus according to the movement data, and the frame content shown by the electronic apparatus is generated according to the moving distance. The user can consistently see the frame content corresponding to the movement of his/her head. As such, the user can truthfully interact with the virtual reality content and pleasantly watch the virtual reality content. However, the present disclosure is not limited in this regard, another communication technology is within the contemplate scope of the present disclosure.

### BRIEF DESCRIPTION OF THE DRAWINGS

FIG. 1A-1B are a block diagrams of a movement tracking system according to one embodiment of the present invention.

FIG. 2 is a flowchart of a movement tracking method according to one embodiment of the present invention.

FIGS. 3A-3B depict schematic diagrams of capturing frames according to one embodiment of present invention.

FIG. 4 depicts schematic diagram of captured frames according to one embodiment of present invention.

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

It will be understood that, although the terms “first,” “second,” “current,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

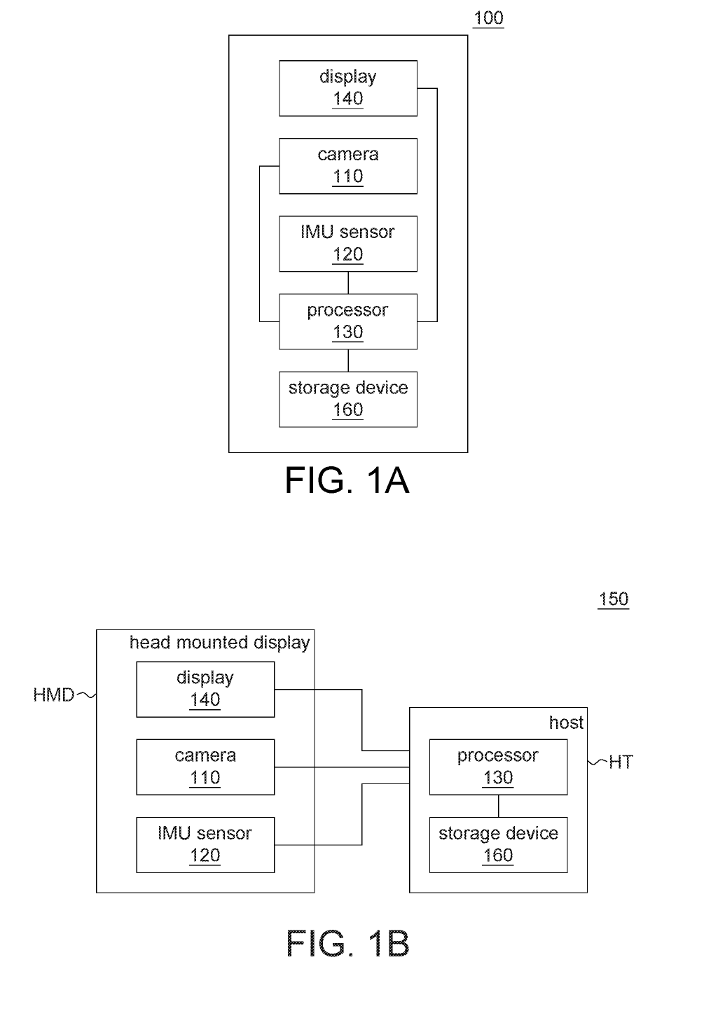

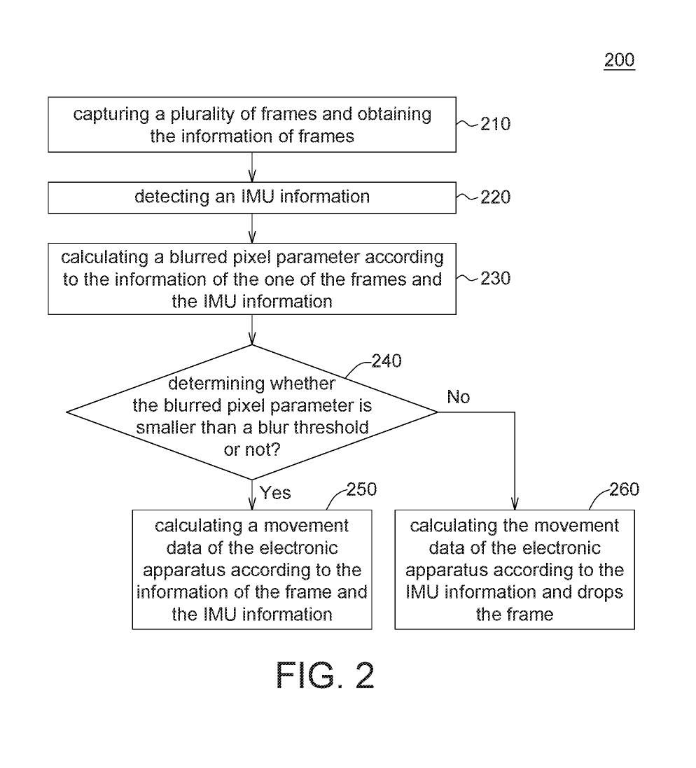

Reference is made to FIGS. 1A-1B and FIG. 2. FIG. 1A is a block diagram of a movement tracking system 100 according to one embodiment of the present invention. FIG. 1B is a block diagram of a movement tracking system 150 according to one embodiment of the present invention. FIG. 2 is a flowchart of a movement tracking method according to one embodiment of the present invention.

In one embodiment, as shown in FIG. 1A, the movement tracking system 100 includes a camera 110, an (inertial measurement unit) IMU sensor 120 and a processor 130. In one embodiment, the camera 110 may be implemented by a CCD (Charge Coupled Device) or a CMOS (Complementary Metal-Oxide Semiconductor). In one embodiment, the IMU sensor 120 is configured for detecting the movement of object(s) to obtain the IMU information. In one embodiment, the IMU sensor 120 includes an accelerometer, a G-sensor, a gyroscope, a magnetometer, a magnetic sensor and/or an electrical compass. In one embodiment, the processor 130 can be implemented by a microcontroller, a microprocessor, a digital signal processor, an application specific integrated circuit (ASIC), or a logic circuit. In one embodiment, the movement tracking system 100 further comprises a display 140 to display the image content providing by the processor 130 or other electronic device. In one embodiment, the movement tracking system 100 further comprises a storage device 160 coupled to the processor 130. The storage device 160 is configured for temporally or permanently storing information and/or some parameters. The storage device 160 can be a memory, a disk, a storage media, or a memory card, etc.

In one embodiment, the movement tracking system 100 can be applied in an electronic apparatus. The electronic apparatus can be a head mounted display.

In one embodiment, as shown in FIG. 1B, the movement tracking system 150 includes a head mounted display HMD and a host HT. In this embodiment, the head mounted display HMD includes a camera 110 and an IMU sensor 120. In one embodiment, the head mounted display HMD further comprises a display 140. The host HT comprises a processor 130. In one embodiment, the processor 130 connects to the display 140, the camera 110, and the IMU sensor 120 by wire/wireless. The processor 130 receives the information of frames captured from the camera 110 and the IMU sensor 120 and transmits suitable frame(s) data to the display 140. In one embodiment, the host HT further comprises a storage device 160. In one embodiment, a host HT can be combined in a head mounted display HMD.

The configurations of the components are not limited to FIGS. 1A-1B. The components can be adjusted according to the practical condition. In one embodiment, the movement tracking method 200 can be implemented by the movement tracking system 100 or 150. However, the implementation way of the movement tracking method 200 is not limited thereto.

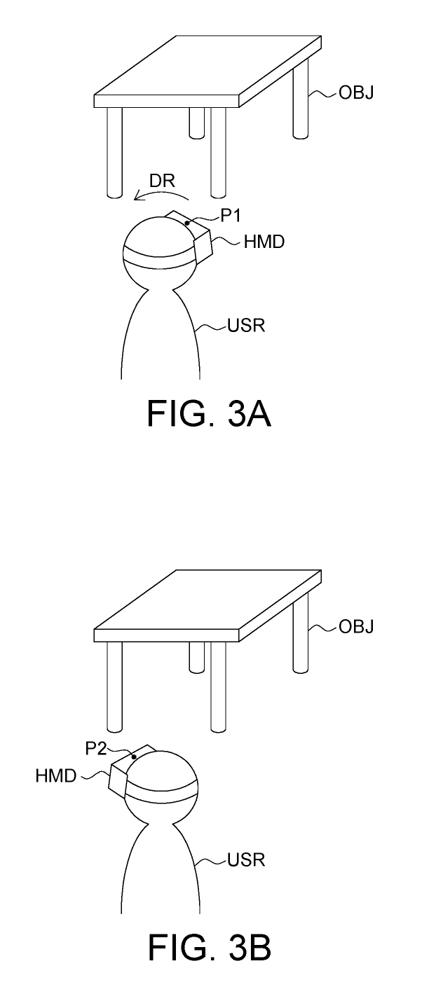

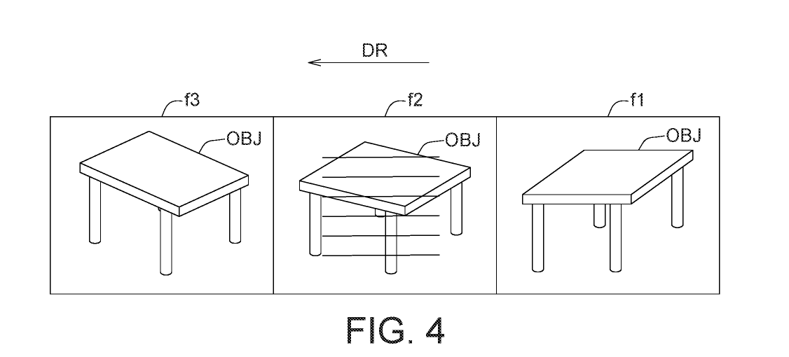

References are made to FIGS. 2, 3A-3B and 4. FIGS. 3A-3B depict schematic diagrams of capturing frames according to one embodiment of present invention. FIG. 4 depicts schematic diagram of captured frames according to one embodiment of present invention.

In step 210, a camera 110 captures a plurality of frames. And, the processor 130 obtains information of the frames. In one example, as shown in FIG. 3A, the user USR wears the head mounted display HMD on his/her head. And, the camera 110 of the head mounted display HMD captures the image of the object OBJ, which the user USR is watching, to obtain the information of one of the frames at the initial head position P1. The information includes frame size, pixel data, resolution and/or captured position.

In step 220, an IMU sensor 120 detects IMU information. In one embodiment, the IMU sensor 120 includes at least one accelerometer for detecting acceleration along each X axis, Y axis and Z axis. The IMU sensor 120 also includes a gyroscope for detecting rotation speed of user's head. As such, the IMU information includes an accelerometer parameter (e.g., acceleration along each X axis, Y axis and Z axis) and/or a gyroscope parameter (e.g., rotation speed).

In one embodiment, the IMU sensor 120 continuously detects the

IMU information after the head mounted display HMD is powered on. The IMU information is stored in the storage device 160.

In step 230, a processor 130 calculates a blurred pixel parameter according to the information of the one of the frames and the IMU information.

In one embodiment, the blurred pixel parameter can be the number of blurred pixels in the one of the frames or a percentage of blurred pixels of all the pixels in the frame.

In one embodiment, the processor 130 calculates a blurred pixel parameter according to the information of frame, the accelerometer parameter and the gyroscope parameter. For example, as shown in FIGS. 3A-3B, the user USR watches the object OBJ and moves his/her head form the initial head position P1 (see FIG. 3A) to the end head position P2 (see FIG. 3B) along the direction DR. During the moving process, as shown in FIG. 4, the camera 110 captures three frames sequentially. The first frame f1 of the three frames is captured at the initial head position P1. The third frame f3 of the three frames is captured at the end head position P2. The second frame f2 of the three frames is captured when the user USR moving his/her head fast with an acceleration before reaching the end head position P2. Therefore, the second frame f2 is high possibility to be a blurred frame having large amount of the blurred pixels. Values of the accelerometer parameter (e.g., acceleration along each X axis, Y axis and Z axis) detected by the accelerometer and value of the gyroscope parameter (e.g., rotation speed) detected by the gyroscope is also higher when the camera 110 captures the second frame f2. As such, the blurred pixel parameter of second frame f2 is higher than the first frame f1 and third frame f3.

In one embodiment, the number of blurred pixels can be calculated by known algorithm. For example, the formula: v=(Sx*d)/T=z*(K*Sx)/(T*f), the notation v represents the speed of moving object, the notation Sx represents pixel size, the notation f represents the focal length of camera 110, the notation T represents the shuttle speed of camera 110, the notation z represents the distance from the camera 110 to the moving object, and the notation K represents the number of blurred pixels. The parameter of the notations v, Sx, f, T and z can be obtained by the information of the frames (e.g, the parameter of the notation Sx), the IMU information (e.g., the parameter of the notation v), pre-configured data (e.g., the parameter of the notation f, the parameter of the notation z) and/or inputted data (e.g., the parameter of the notation T). Once the parameter of the notations v, Sx, f, T and z are obtained, the notation K (which represents the number of blurred pixels) can be calculated. The method for calculating the number of blurred pixels is not limited thereto.

In step 240, the processor 130 determines whether the blurred pixel parameter is smaller than a blur threshold or not. If the blurred pixel parameter is smaller than the blur threshold, step 250 is performed. If the blurred pixel parameter is higher than or equal to the blur threshold, step 260 is performed.

In one embodiment, the blur threshold can be a percentage threshold. For example, if the blurred pixel parameter is 20% and the blur threshold 50%, the processor 130 determines that the blurred pixel parameter is smaller than a blur threshold. For example, if the blurred pixel parameter is 80% and the blur threshold 50%, the processor 130 determines that the blurred pixel parameter is not smaller than a blur threshold.

In step 250, the processor 130 calculates a movement data of the electronic apparatus (e.g., head mounted display HMD) according to the information of the frame (e.g., second frame f2) and the IMU information. The movement of the electronic apparatus can be tracked according to the movement data.

In one embodiment, when the electronic apparatus is the head mounted display HMD, a frame content shown by the head mounted display HMD is generated according to the moving distance. For example, the moving distance of the head mounted display HMD can be calculated according to the movement data, and the frame content shown by the head mounted display HMD is generated according to the moving distance. As such, the user USR can consistently see the frame content corresponding to the movement of his/her head, without uncomfortable or seasick feeling. Some methods for generating the movement data is described as following paragraphs.

In one embodiment, the movement data comprises a rotation degree and a spatial coordinate, and a moving distance of the electronic apparatus is calculated according to the rotation degree and the spatial coordinate.

Because the frame is clear (in step 250), the processor 130 can precisely find the spatial coordinates of the feature points in the frames (e.g., searching the spatial coordinates of the feature points by the color, the shape, and/or the predicted coordinate of the object OBJ in the frames) for generating the movement data.

The rotation degree also can be calculated precisely according to the spatial coordinates of the feature points between two frames in sequence.

In one embodiment, the rotation speed detected by the gyroscope, the acceleration detected by the accelerometer, the depth information obtained from the information of the frame. And, the coordinates of feature points in the previous frame also can use for calculating the movement data.

Thus, the processor 130 has enough information to calculate the movement data according to the information of the frame and the IMU information.

In one embodiment, the movement data can be generated by known algorithm. For example, the movement data is generated by substituting the information of the frame (e.g., some coordinates of some feature points) into a triangulation algorithm and taking the IMU information as reference data in the same time, to obtain the precise result. Due to the triangulation algorithm is a known algorithm, the detailed descriptions thereof will be omitted.

In step 260, the processor 130 calculates the movement data of the electronic apparatus according to the IMU information and drops the frame (e.g., second frame f2). Because the frame has too much blurred pixel, the blurred frame is not applied in step 260.

In this step, the processor 130 calculates the movement data of the electronic apparatus only according to the IMU information without using the frame having too much blurred pixel, for preventing calculating the movement data with lower accuracy result.

Further, the movement tracking method 200 can be applied for the condition of capturing multiple frames. In one embodiment, the camera 110 further captures information of another frame (e.g., the third frame f3 in FIG. 4), and the processor calculates another blurred pixel parameter according to the information of another frame and the IMU information by the processor. If the blurred pixel parameter of the frame (e.g., second frame f2 in FIG. 4) is higher than the blur threshold and the blurred pixel parameter of another frame is smaller than or equal to the blur threshold, the processor 130 calculates the movement data of the electronic apparatus according to information of another frame and the IMU information.

In this embodiment, the movement tracking method and a movement tracking system can precisely calculate the moving distance of the electronic apparatus according to the movement data, and the frame content shown by the electronic apparatus is generated according to the moving distance. The user can consistently see the frame content corresponding to the movement of his/her head. As such, the user can truthfully interact with the virtual reality content and pleasantly watch the virtual reality content. However, the present disclosure is not limited in this regard, another communication technology is within the contemplate scope of the present disclosure.

Although the present invention has been described in considerable detail with reference to certain embodiments thereof, other embodiments are possible. Therefore, the scope of the appended claims should not be limited to the description of the embodiments contained herein.

What is claimed is:

1. A movement tracking method for an electronic apparatus, comprising:
obtaining information of a first frame captured by a camera;
obtaining (inertial measurement unit) IMU information from an IMU sensor;
calculating a first blurred pixel parameter of the first frame according to the information of the first frame and the IMU information by a processor; and
determining whether the first blurred pixel parameter of the first frame is smaller than a blur threshold or not by the processor;
if the first blurred pixel parameter of the first frame is smaller than the blur threshold, calculating a movement data of the electronic apparatus according to the information of the first frame and the IMU information.

2. The movement tracking method of claim 1, wherein if the first blurred pixel parameter is higher than or equal to the blur threshold, the processor calculates the movement data of the electronic apparatus according to the IMU information and drops the first frame.

3. The movement tracking method of claim 1, wherein the IMU information comprises an accelerometer parameter and/or a gyroscope parameter, the movement tracking method further comprising:
calculating the first blurred pixel parameter according to the accelerometer parameter and/or the gyroscope parameter.

4. The movement tracking method of claim 1, wherein the movement data comprises a rotation degree and/or a spatial coordinate, and a moving distance of the electronic apparatus is calculated according to the rotation degree and/or the spatial coordinate.

5. The movement tracking method of claim 4, wherein the electronic apparatus is a head mounted display, and a frame content shown by the head mounted display is generated according to the moving distance.

6. The movement tracking method of claim 1, wherein the movement data is generated by substituting the information of the first frame and the IMU information into a triangulation algorithm.

7. The movement tracking method of claim 1, further comprising:
obtaining information of a second frame from the camera; and
calculating a second blurred pixel parameter according to the information of the second frame and the IMU information by the processor;
wherein if the second blurred pixel parameter is smaller than the blur threshold and the second blurred pixel parameter is higher than or equal to the blur threshold, the processor calculates the movement data of the electronic apparatus according to the information of the second frame and the IMU information.

8. A movement tracking system for an electronic apparatus, comprising:
a camera for capturing a first frame;
an IMU sensor for detecting (inertial measurement unit) IMU information; and
a processor for obtaining information of the first frame and calculating a first blurred pixel parameter of the first frame according to information of the first frame and the IMU information;
wherein the processor determines whether the first blurred pixel parameter is smaller than a blur threshold or not;
if the first blurred pixel parameter of the first frame is smaller than the blur threshold, the processor calculates a movement data of the electronic apparatus according to the information of the first frame and the IMU information.

9. The movement tracking system of claim 8, wherein if the first blurred pixel parameter is higher than or equal to the blur threshold, the processor calculates the movement data of the electronic apparatus according to the IMU information and drops the first frame.

10. The movement tracking system of claim 8, wherein the IMU information comprises an accelerometer parameter and/or a gyroscope parameter, and the processor calculates the first blurred pixel parameter a the accelerometer parameter and/or gyroscope parameter.

11. The movement tracking system of claim 8, wherein the movement data comprises a rotation degree and/or a spatial coordinate, and a moving distance of the electronic apparatus is calculated according to the rotation degree and/or the spatial coordinate.

12. The movement tracking system of claim 11, wherein the electronic apparatus is a head mounted display, and a frame content shown by the head mounted display is generated according to the moving distance.

13. The movement tracking system of claim 8, wherein the movement data is generated by substituting the information of the first frame and the IMU information into a triangulation algorithm.

14. The movement tracking system of claim 1, wherein the camera captures information of a second frame, and the processor calculates a second blurred pixel parameter according to the information of the second frame and the IMU information by the processor;
wherein if the second blurred pixel parameter is smaller than the blur threshold and the another second pixel parameter is higher than or equal to the blur threshold, the processor calculates the movement data of the electronic apparatus according to the information of the second frame and the IMU information.
